(19) United States
(12) Patent Application Publication
(10) Pub. No.: US 2019/0362298 A1
(43) Pub. Date: Nov. 28, 2019

(54) METHOD FOR THE DISTRIBUTION OF VEHICLE CONSUMABLES

(71) Applicant: Faurecia Emissions Control Technologies, USA, LLC, Columbus, IN (US)

(72) Inventors: James Egan, Indianapolis, IN (US); Wallace Tallent, Seymour, IN (US)

(21) Appl. No.: 15/985,804

(22) Filed: May 22, 2018

(51) Int. Cl. G06Q 10/08; F01N 3/20

(52) U.S. Cl. CPC G06Q 10/087; F01N 3/208; F01N 2900/1814; F01N 2610/02; F01N 2450/30

(57) ABSTRACT

A method for distributing vehicle consumables includes providing at least one vehicle feature that includes at least one consumable item, monitoring a level of consumption of the at least one consumable item, and identifying when the level of consumption reaches a predetermined order replacement level. A replacement is ordered for the at least one consumable item when the predetermined order replacement level is reached. In one example, the at least one consumable item comprises ammonia in gaseous form that is released from a cartridge that is reusable.

### FIELD OF INVENTION

The present invention generally relates to a method for distributing vehicle consumables such as ammonia cartridges, diesel exhaust fluid, etc., for example.

### BACKGROUND OF THE INVENTION

There is a legal requirement for reducing the emission level of vehicles year over year. For example, improved NOx reduction is required in response to these stricter emission requirements. One example of a traditional NOx reduction system includes a mixer with an injection system that injects a fluid, such as diesel exhaust fluid (DEF) or other similar reagent for example, to produce ammonia that mixes with exhaust gas prior to entry into a selective catalytic reduction (SCR) catalyst. One method for improving NOx reduction is to use ammonia instead of DEF. The ammonia can be stored within cartridges that are part of an Ammonia Storage and Delivery System (ASDS™). The use of ammonia in this form significantly reduces the amount of mixing with exhaust gas that is required with DEF systems. Ammonia in this form also performs efficient NOx reduction at much lower temperatures than traditional systems. The majority of NOx is produced at vehicle start-up, which is when the SCR catalyst is cold. Because the ammonia performs efficient NOx reduction at lower temperatures than DEF based traditional systems, the overall vehicle NOx production can be significantly reduced.

In one example, the ammonia is bound with a binding agent to Adammine™ in solid form in a cartridge and is released in a gaseous form as the cartridge is heated. The cartridges and binding agent can be reused many times. One challenge with using this type of system is that the infrastructure necessary to supply cartridges and collect empty cartridges is not as well developed as that for DEF systems. DEF is readily available at stores, gas stations, dealerships, freight depos, etc., while ammonia cartridges are not. This makes ASDS less desirable as finding replacement cartridges is difficult.

### SUMMARY OF THE INVENTION

Distribution of vehicle consumables presents several challenges. According to one exemplary embodiment, a method for distributing vehicle consumables includes providing at least one vehicle feature that includes at least one consumable item, monitoring a level of consumption of the at least one consumable item, and identifying when the level of consumption reaches a predetermined order replacement level. A replacement is ordered for the at least one consumable item when the predetermined order replacement level is reached. In one example, the at least one consumable item comprises ammonia in gaseous form that is stored within a cartridge that is reusable.

In a further embodiment of the above, the at least one consumable item is included within a container that is reusable.

In a further embodiment of either of the above, a vehicle with the consumable item automatically generates an order signal that is communicated to a distribution system when the predetermined order replacement level is reached

According to another exemplary embodiment, a method for distributing vehicle consumables includes providing at least one vehicle exhaust component that includes at least one cartridge that releases ammonia in gaseous form, monitoring a level of consumption of the ammonia, and identifying when the level of consumption reaches a predetermined order replacement level. A replacement cartridge is ordered when the predetermined order replacement level is reached.

These and other features of the present invention can be best understood from the following specification and drawings, the following of which is a brief description.

### BRIEF DESCRIPTION OF THE DRAWINGS

FIG. 1 schematically illustrates one example of an exhaust system with a mixer according to the subject invention.

FIG. 2 shows a first example embodiment of the subject invention.

FIG. 3 shows another example embodiment of the subject invention.

FIG. 4 shows another example embodiment of the subject invention.

### DETAILED DESCRIPTION

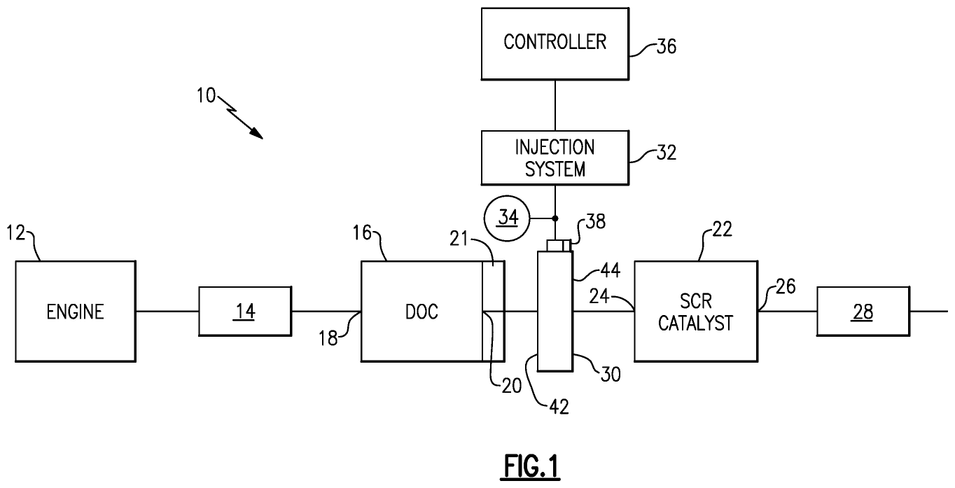

FIG. 1 shows a vehicle exhaust system 10 that conducts hot exhaust gases generated by an engine 12 through various upstream exhaust components 14 to reduce emission and control noise as known. The various upstream exhaust components 14 can include one or more of the following: pipes, filters, valves, catalysts, mufflers etc.

In one example configuration, the upstream exhaust components 14 direct engine exhaust gases into a diesel oxidation catalyst (DOC) 16 having an inlet 18 and an outlet 20. Downstream of the DOC 16 there may be a diesel particulate filter (DPF) 21 that is used to remove contaminants from the exhaust gas as known. Downstream of the DOC 16 and optional DPF 21 is a selective catalytic reduction (SCR) catalyst 22 having an inlet 24 and an outlet 26. The outlet 26 communicates exhaust gases to downstream exhaust components 28. Optionally, component 22 can comprise a catalyst that is configured to perform a selective catalytic reduction function and a particulate filter function. The various downstream exhaust components 28 can include one or more of the following: pipes, filters, valves, catalysts, mufflers etc. These upstream 14 and downstream 28 components can be mounted in various different configurations and combinations dependent upon vehicle application and available packaging space.

A mixer 30 is positioned downstream from the outlet 20 of the DOC 16 or DPF 21 and upstream of the inlet 24 of the SCR catalyst 22. The upstream catalyst and downstream catalyst can be in-line or in parallel. The mixer 30 is used to generate a swirling or rotary motion of the exhaust gas.

An injection system 32 is used to inject ammonia in gaseous form into the exhaust gas stream upstream from the SCR catalyst 22 such that the mixer 30 can mix the ammonia and exhaust gas thoroughly together. The injection system 32 includes one or more cartridges 34 that store the ammonia, an injector 38, and a controller 36 that controls injection of the ammonia as known. The mixer 30 comprises a mixer body having an inlet or upstream end 42 configured to receive the engine exhaust gases and an outlet or downstream end 44 to direct a mixture of swirling engine exhaust gas and ammonia to the SCR catalyst 22.

The ammonia is bound within the cartridge 34 in solid form and is released in a gaseous form as the cartridge is heated. The cartridges 34 can be reused many times. Over time, the ammonia within the cartridge 34 is depleted and it becomes necessary to replace the cartridge 34. Thus, the cartridge 34 comprises a vehicle consumable product or item that must be continuously replaced during the lifetime of the vehicle.

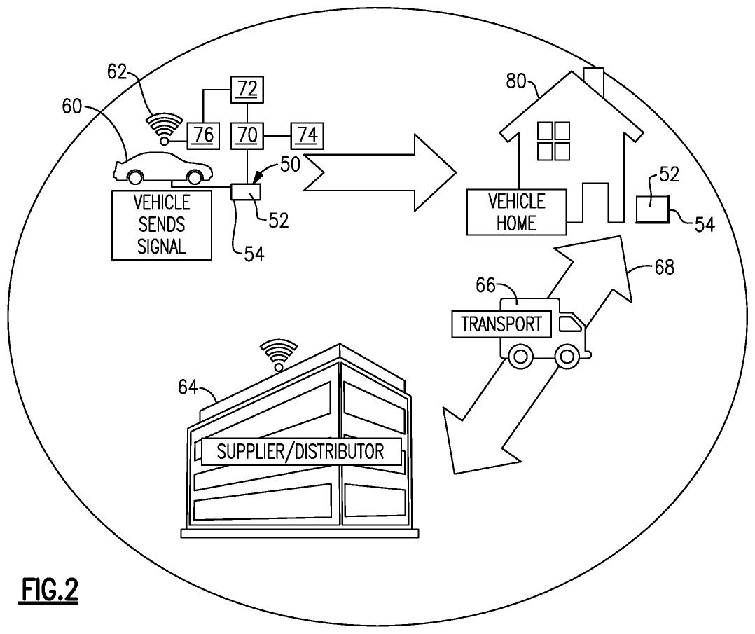

Example methods for distributing vehicle consumables are shown in FIGS. 2-4. A consumable item is intended to cover structures that can be reused or recycled. The methods each include providing at least one vehicle system or feature 50 that includes at least one consumable and/or recyclable item 52, such as an ammonia cartridge 34 for example. In this example the consumable item 52 is included within a cartridge container 54 that is reusable. The level of consumption of the consumable item is monitored and the method further includes identifying when the level of consumption reaches a predetermined order replacement level. The predetermined order replacement level could be when a certain percentage of the consumable item has been depleted or when the consumable item is fully depleted, for example. A replacement is ordered when the predetermined order replacement level is reached.

As discussed above, in one example the consumable item 52 is ammonia for an ammonia cartridge 34. However, it should be understood that the subject methods could also be applied to other systems or features of the vehicle that include vehicle consumables such as DEF, brake pads, coolant, oil, washer fluid, filters, etc. Each method utilizes a monitoring system, which is pre-existing or that can be added, to monitor depletion of fluid, coolant, oil, etc. or brake pad wear, filter life etc., and which then cooperates with a control system to determine when a replacement is necessary. The monitoring system communicates data to the control system which can then order a replacement that can be delivered to a residence, workplace, depo, etc. The control and monitoring systems will be discussed in greater detail below.

FIG. 2 shows one example method where a vehicle 60 with the consumable item 52 automatically generates an order signal 62 that is communicated to a distribution system 64, such as a supplier for example, when the predetermined order replacement level is reached. A distributor 66 from the distribution system 64 delivers the replacement consumable item 52 to a predetermined location in response to the order signal 62 as indicated at 68. The distributor 66 automatically collects any empty containers 54 that are at the predetermined location to return the containers 54 to the distribution system 64 for reuse.

A monitoring system 70 monitors depletion of the consumable item and communicates with a controller 72 of the control system. The controller 72 can be part of an existing vehicle control system or can be a separate controller that is dedicated to monitoring one or more consumable items. The monitoring system 70 can include one or more sensors 74 that are used to measure/monitor any of various characteristics of the consumable item. The monitoring system 70 can directly measure a level of consumption using the sensors 74 or can estimate a level of consumption over time.

The monitoring system 70 communicates this data to the controller 72 which can then determine whether a replacement is necessary. When it is determined that a replacement is necessary, an order can then be placed to the distribution system 64 via a communication device 76. In one example, the communication device 76 comprises a vehicle on-board tele-communication system such as GM On-Star®, Ford Sync®, or FCA UConnect®, for example. Optionally, the communication device 76 can be a standalone system that is part of a system associated with the consumable item, such as the ASDS for example. This would be preferred for retrofitting ASDS on existing vehicles.

The controller 72 can, for example, include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 72 may be a hardware device for executing software, particularly software stored in memory. The controller 72 can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory which is used to determine whether replacements are needed is based on information from the monitoring system 70 and may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) to communicate with the controller 72 may include input devices, for example but not limited to, a keyboard, mouse, scanner, microphone, camera, proximity device, etc. Further, the Input/Output devices may also include output devices to communicate from the controller 72, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

The controller 72 can be configured to execute software stored within the memory, to communicate data to and from the memory, and to generally control operations of the computing device pursuant to the software. Software in memory, in whole or in part, is read by the processor, perhaps buffered within the processor, and then executed to determine when replacements are needed.

In the example shown in FIG. 2, the vehicle 60 is a personal vehicle that includes an ASDS with one or more cartridges 34, and the predetermined delivery location is a workplace or residence 80. The vehicle 60 automatically generates the order signal 62 that is communicated to the distribution system 64 when the controller 72 determines a replacement cartridge is needed. The distributor 66, such as a transport vehicle from the distribution system 64, then delivers the replacement cartridge to the residence 80. The distributor 66 automatically collects any empty cartridges that are at the residence to return the cartridges to the distribution system 64 for reuse.

In one example, a two cartridge system is used that includes at least first and second cartridges 34. When the first cartridge is empty, the order signal 62 is generated to order a replacement cartridge and the vehicle operates off of the second cartridge. In another example, a single cartridge system is used. The level of consumption of the single cartridge is directly measured or is estimated as discussed above to determine when the predetermined order replacement level is reached.

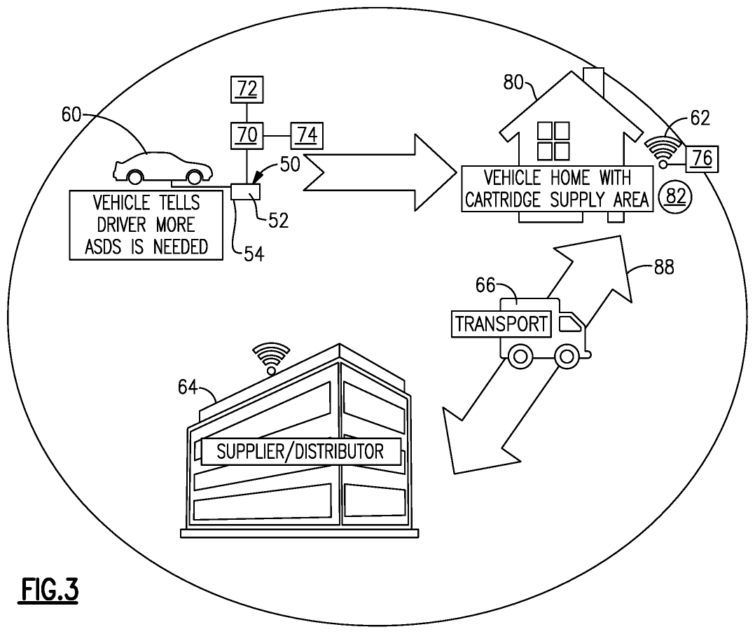

FIG. 3 shows another example where the residence 80 includes a predetermined supply area 82 that stores one or more replacement cartridges. In this example, the vehicle 60 automatically notifies the user/driver via the controller 72 that the predetermined order replacement level has been reached such that the driver can return to the residence 80 to obtain a replacement cartridge from the predetermined supply area 82. The notification can be an audio and/or visual indicator that is communicated to the driver via a communication interface. When the driver takes a cartridge 34 from the supply at the supply area 82, the communication device 76 can automatically generate the control signal 62 to order a cartridge to replace the one that was taken by the driver. Optionally, the driver may initiate the order of the replacement using the communication device 76. The distributer 66 will then come to the supply area 82 and exchange the empty cartridge for a full cartridge as indicated at 88.

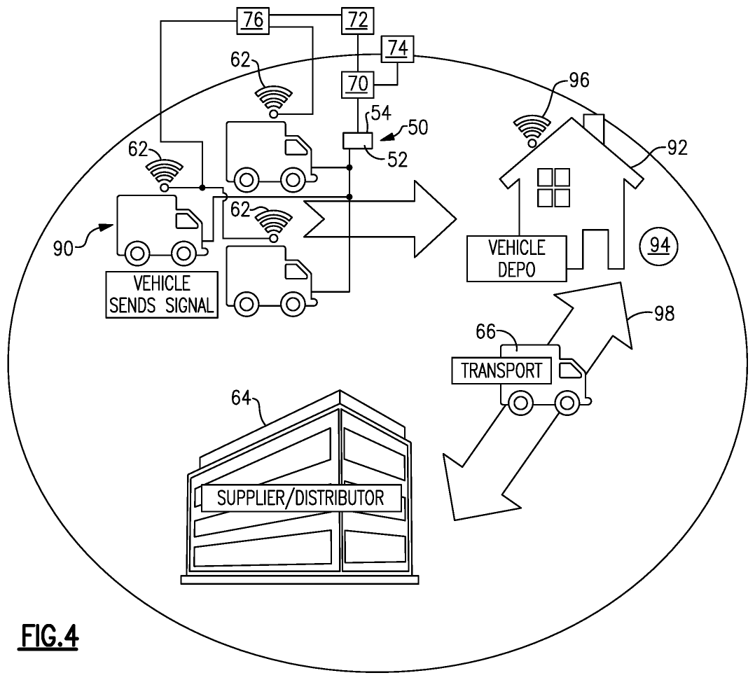

FIG. 4 shows another example where a fleet of commercial vehicles 90 utilizes at least one common consumable item 52 and wherein each vehicle automatically generates an order signal 62 that is communicated to a vehicle depo 92 when the predetermined order replacement level is reached. The vehicle depo 92 has a supply 94 of replacements for the common consumable item 52. When one of the vehicles 90 needs a replacement cartridge, the driver returns to the depo 92 and takes a new cartridge from the supply 94 and leaves the empty cartridge.

An operator or computer system at the vehicle depo 92 determines when to notify the distribution system 64 to resupply the replacement cartridges based on depletion of the supply. When a resupply is needed, the operator generates an order signal 96 via a communication interface that is communicated to the distribution system 64. The distributor 66 drives to the depo 92 to swap out the empty cartridges with replacement cartridges as indicated at 98. The commercial vehicles 90 reduce cost by recycling empty for full cartridges.

One additional option, which can be used in any of the examples, is to store empty containers/cartridges in a locked storage area. Thus, the cartridges can be secured and kept safe from theft. The distributer can unlock the cartridges such that they can be returned for reuse.

The distribution system 64 can comprise a supplier for the consumable item or can be a store or online ordering system, such as Amazon® for example. Amazon utilizes dash buttons for specific items such as toothpaste, detergent, paper towel, etc. that, when pressed, automatically order the item identified on the button as part of a Dash Replenishment Service®. The subject invention could communicate a replacement order through Amazon using a dash button or by using an app via a handheld device such as a smart phone for example. Optionally, an onboard vehicle diagnostic system can compile replenishment data using various vehicle sensors to monitor consumable levels and then wirelessly communicate with the distribution system to order replacements as needed. Thus, the subject invention provides a method of automatically ordering a replacement of a vehicle consumable in response to monitoring the level of consumption. This makes systems such as ASDS more attractive due to the improved accessibility to replacement cartridges.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

1. A method for distributing vehicle consumables comprising:
providing at least one vehicle feature that includes at least one consumable item;
monitoring a level of consumption of the at least one consumable item;
identifying when the level of consumption reaches a predetermined order replacement level; and
ordering a replacement for the at least one consumable item when the predetermined order replacement level is reached.

2. The method according to claim 1 wherein the at least one consumable item is included within a container that is reusable or recyclable.

3. The method according to claim 2 wherein a vehicle with the consumable item automatically generates an order signal that is communicated to a distribution system when the predetermined order replacement level is reached.

4. The method according to claim 3 wherein a distributor from the distribution system delivers the at least one consumable item to a predetermined location in response to the order signal.

5. The method according to claim 4 wherein the distributor collects any empty containers that are at the predetermined location to return the containers to the distribution system.

6. The method according to claim 2 including providing a predetermined supply area that includes one or more replacements for the at least one consumable item, and wherein a vehicle with the consumable item automatically notifies a user via a communication interface that the predetermined order replacement level has been reached such that the user can obtain a replacement from the predetermined supply area.

7. The method according to claim 6 wherein the predetermined supply area automatically generates an order signal that is communicated to a distribution system when the user takes the replacement.

8. The method according to claim 7 wherein, in response to the order signal, a distributor delivers one or more replacements and collects any empty containers that are at the predetermined supply area to return the containers to the distribution system.

9. The method according to claim 2 wherein a fleet of vehicles utilizes at least one common consumable item and wherein each vehicle automatically generates an order signal that is communicated to a vehicle depo when the predetermined order replacement level is reached.

10. The method according to claim 9 wherein the vehicle depo has a supply of replacements for the common consumable item, and wherein an operator at the vehicle depo determines when to notify a distribution system to resupply the replacements based on depletion of the supply.

11. The method according to claim 2 including storing empty containers in a locked storage area.

12. The method according to claim 1 wherein the at least one consumable item comprises ammonia in gaseous form that is released from a cartridge that is reusable.

13. The method according to claim 1 wherein monitoring the level of consumption of the at least one consumable item includes directly measuring a level of consumption and communicating measurements to a control system.

14. The method according to claim 1 wherein monitoring the level of consumption of the at least one consumable item includes estimating a level of consumption over time to determine when the predetermined order replacement level is reached.

15. A method for distributing vehicle consumables comprising:
providing at least one vehicle exhaust feature that includes at least one cartridge that releases ammonia in gaseous form;
monitoring a level of consumption of the ammonia;
identifying when the level of consumption reaches a predetermined order replacement level; and
ordering a replacement cartridge when the predetermined order replacement level is reached.

16. The method according to claim 15 wherein the at least one cartridge comprises at least first and second cartridges, and including automatically ordering a replacement cartridge from a distribution system via an on-board vehicle communication system when one of the first and second cartridges is empty.

17. The method according to claim 16 wherein a distributor from the distribution system delivers the replacement cartridge to a predetermined location in response to the order signal.

18. The method according to claim 17 wherein the predetermined location is a residence for a driver of a vehicle that has ordered the replacement cartridge.

19. The method according to claim 18 wherein the distributor automatically collects any empty cartridges that are at the residence to return the cartridges to the distribution system for reuse.

20. The method according to claim 1 wherein the at least one cartridge comprises a single cartridge and wherein monitoring the level of consumption includes directly measuring a level of ammonia, or estimating a level of ammonia depletion over time, to determine when the predetermined order replacement level is reached.
